(19) United States
(12) Patent Application Publication
(10) Pub. No.: US 2017/0241080 A1
(43) Pub. Date: Aug. 24, 2017

(54) Method for the Continuous Coating of a Cellulose-Based Fibrous Substrate Web with Fatty Acid Chloride

(71) Applicant: DELFORTGROUP AG, Traun (AT)

(72) Inventors: Christian Eichholz, Mannheim (DE); Hubertus Kröner, Neustadt (DE); Benjamin Schmidt-Hansberg, Karlsruhe (DE); Lukas Wengeler, Ludwigshafen (DE); Jochen Gattermayer, Messel (DE); Nils Lawrenz, Worms (DE)

(21) Appl. No.: 15/501,508

(22) PCT Filed: Aug. 6, 2015
(86) PCT No.: PCT/IB2015/055961

§ 371 Date: Feb. 3, 2017

(30) Foreign Application Priority Data
Aug. 6, 2014 (EP) 14180103.5

(51) Int. Cl. D21H 25/02; D21H 23/22; D21H 25/04; B05D 3/02; D21H 27/10; D21H 19/14; B05D 3/04; D21H 21/16; D21H 27/00

(52) U.S. Cl. CPC D21H 25/02; D21H 21/16; D21H 23/22; D21H 25/04; D21H 27/002; D21H 27/10; D21H 19/14; B05D 3/0406; B05D 3/0254

(57) ABSTRACT

The present invention concerns a process for continuously coating a cellulose-based fibrous substrate web with fatty acid chloride, comprising the steps of a) pre-drying a cellulose-based fibrous substrate web to an EN ISO 638:2008 dry matter content of less than 10%; b) coating the cellulose-based fibrous substrate web pre-dried in step a) with a liquid fatty acid chloride composition at a DIN EN 20187 relative humidity of less than 20 rH and a temperature below the boiling temperature of the liquid fatty acid chloride composition; c) thermally treating the coated cellulose-based fibrous substrate web obtained from step b).

The present invention relates to a method for continuously coating a cellulose-based fibrous substrate web with fatty acid chloride and a coating device for the continuous coating of the fibrous substrate web with a liquid fatty acid chloride composition.

### BACKGROUND OF THE INVENTION

The treatment of cellulose-based fibrous substrate webs such as paper, paperboard or carton with hydrophobizing substances is known and is one option for reducing the penetration of moisture into fibrous substrates. In this manner, the stability of cellulose-based fibrous substrates can be at least partially maintained even they are exposed to moisture.

In the prior art it is known to coat cellulose-based fibrous substrates with waxes. Such coatings provide good hydrophobic properties, but they have the disadvantage that the waxed fibrous substrates cannot be recycled, or at least only with difficulty. This also applies to many other hydrophobizing substances known in the prior art. Thus, generally, such coated fibrous substrates cannot be returned to the normal paper recycling process.

Further, in order to hydrophobize cellulose-based fibrous substrates it is known to treat them with fatty acid chlorides. Among the methods for the treatment of cellulose-based fibrous substrates, solvent-based and solvent-free methods are known.

In the solvent-based methods, the fatty acid chloride is dissolved in an organic solvent before application to a fibrous substrate web. While the solvent is evaporated in a thermal dryer, the applied fatty acid chloride reacts with the hydroxyl groups of the fibrous paper substrate to form covalently bonded fatty acid with the generation of hydrogen chloride. For the solvent-based methods, safe handling of the solvent is not without problems and there is a risk of explosion due to the usually high content of solvent. Thus, in a process for the production of a fibrous substrate web, these methods can only be used if strict safety measures are employed. Solvent-free methods for coating with fatty acid chlorides, on the other hand, have the disadvantage of providing poorer hydrophobic properties and that a high proportion of fatty acids is not bonded to the fibrous substrate web, which puts a load on the production cycle. A further disadvantage of known methods is that very large quantities have to be applied in order to obtain good hydrophobic properties.

WO 99/08784 describes a method for the treatment of a solid, hydrophilic material, e.g. paper or glass, with a composition comprising a reactive hydrophobizing reagent, particularly a fatty acid chloride, which reacts with the hydrophilic material with the formation of covalent bonds, so that a hydrophobic impregnation is obtained. To this end, a solution of the reactive hydrophobizing reagent in an organic solvent is applied to the material in such a manner that the hydrophobizing reagent is deposited in finely distributed form, i.e. in the form of a micro-dispersion. After that, an air flow is applied to the treated material, wherein the hydrophobizing reagent reacts with the substrate with the formation of a covalent bond and volatile substances, particularly hydrogen chloride, which are released during the reaction of the hydrophobizing reagent with the substrate, are removed. The method requires the use of large quantities of organic solvent.

US 2013/0236647A1 describes a method for the treatment of cellulose-based fibrous substrates, for example paper, paperboard or carton, with fatty acid chloride by gravure coating. After gravure coating the cellulose-based fibrous substrate with fatty acid chloride, the cellulose-based fibrous substrate web is guided over a drying cylinder for drying and is dried by contact drying. Large proportions of fatty acid, which are not bound to the cellulose-based fibrous substrate, are of disadvantage and put a load on the production cycle.

A similar method is known from US 2014/0113080, wherein at first, a cellulose-based fibrous substrate, for example paper, is coated with polyvinyl alcohol and then an activated fatty acid is deposited on the surface coated with polyvinyl alcohol, wherein the fibrous substrate is heated to a temperature above the melting point of the activated fatty acid.

### SUMMARY OF THE INVENTION

The object of the present invention is to provide an improved method for the continuous coating of a fibrous substrate web with fatty acid chloride, which as far as possible avoids the aforementioned disadvantages. In particular, the method shall result in products that are comparable with wax coatings regarding the hydrophobization achieved and the durability, and thus provide a wax replacement. Further, the products produced according to the method according to the invention shall fulfill the requirements of paper recycling and shall be recyclable.

Surprisingly, it was found that the objective can be achieved by a method for the continuous coating of a cellulose-based fibrous substrate web with fatty acid chloride, comprising the steps of
a) pre-drying a cellulose-based fibrous substrate web to a moisture content in accordance with EN ISO 638:2008 of less than 5%, particularly less than 4%, and particularly preferably at most 3% or at most 2%;
b) coating the pre-dried cellulose-based fibrous substrate web of step a) with a liquid fatty acid chloride composition at a relative humidity in accordance with DIN EN 20187 of less than 20% rH and a temperature below the boiling temperature of the liquid fatty acid chloride composition;
c) contact-less or contact-free thermal treatment of the coated cellulose-based fibrous substrate web obtained from step b).

Fibrous substrate webs produced with the method according to the invention fulfil the requirement of recyclability in conventional paper recycling or improve their recyclability, due to the type of hydrophobizing reagent. The products produced by the method according to the invention also have good hypdrophizing properties for small amounts of applied fatty acid chlorides and also exhibit good, in particular sufficient, strength properties and also fulfill the testing standards requirements upon and/or after exposure to moisture, for example upon exposure to moisture for 30 minutes. Examples for testing standards are the tear strength in accordance with EN ISO 1924-05:2009, the Short-Crush-Test in accordance with DIN 54518-03:2004, the edge wicking test (http://www.istgrafika.com/preuzimanja/files/Important-Parameters-for-Paper-and-Paperboard_Technical_Notes.pdf) and the Cobb Test in accordance with DIN EN 20535-10:1981. In particular, further processed products, particularly boxes, cases, packages, crates and the like, which are further processed from products produced by the method according to the invention, still have a sufficient or improved stability after exposure to moisture.

Thus the object of the invention is a method for continuous coating of a cellulose-based fibrous substrate web with fatty acid chloride, comprising the steps a) to c) as defined before and as follows.

A further object of the invention is a coating device, which is suitable for the continuous coating of a cellulose-based fibrous substrate web with a liquid fatty acid chloride composition in accordance with the method of the invention and which comprises the following components:
1. a pre-drying module;
2. a coating module and
3. a module for thermal post-treatment.

In this regard, at least one of the modules of the coating device is enclosed and has an atmosphere of dry air with a relative humidity in accordance with DIN EN 20187 of less than 20% rH, preferably less than 10% rH, particularly preferably of less than 5% rH. Naturally the modules 1-3 are arranged such that the cellulose-based fibrous substrate web can be guided continuously through the modules in the specified order. Step a) is carried out in the pre-drying module coating step b) is carried out in the coating module and the contact-free thermal post-treatment is carried out in the module for thermal post-treatment.

A further object of the invention is the use of a cellulose-based fibrous substrate web, obtainable by the method according to the invention, for the production of base paper for corrugated board, packaging paper, cardboard, paperboard, hygienic paper, tissue, printing paper, writing paper and combinations thereof.

### DETAILED DESCRIPTION OF THE INVENTION

In the context of the present invention, a cellulose-based fibrous substrate web is understood to be a substrate based on cellulose, which is processed to a web and contains at least a fibrous material based on cellulose as the main component. Examples of fibrous materials based on cellulose include cellulose fibers, pulp, chemo-thermo-mechanical pulp (CTMP), thermo-mechanical pulp (TMP), deinked pulp (DIP), mechanical wood pulp, groundwood pulp, fiber pulp with hydrophilic properties and a combination thereof. Typical fibrous substrate webs are paper, paperboard and cardboard. The main component of fibrous substrate webs is the fibrous material based on cellulose. Further components of the fibrous substrate webs can be fillers such as, for example, mineral and/or organic pigments, fines, particularly hemi-celluloses, (shading) colorants, chemical additives, particularly retention aids, fixing agents, impurity-binding agents, (dry) strength enhancers, sizing agents, de-foaming agents and other process aids.

Cellulose-based fibrous substrate webs can be coated or uncoated. Typically, the coatings can be coatings with conventional, starch-containing paper coating compositions.

In one embodiment of the invention, no cellulose-based fibrous substrate webs are used, which have been pre-treated with polyvinyl alcohol. Here and herein below, polyvinyl alcohol shall also be understood to refer to partially hydrolyzed polyvinyl acetates, particularly those with a degree of hydrolysis of >80%.

In the context of the present invention, fatty acid chlorides shall be understood to mean chlorides of aliphatic monocarboxylic acids, which in general have at least 6, particularly at least 8 carbon atoms. In particular, the monocarboxylic acids have 12 to 26 carbon atoms. The fatty acids can be saturated or unsaturated. In particular, they are fatty acid chlorides of saturated aliphatic monocarboxylic acids, particularly fatty acid chlorides with 12 to 26 C atoms, such as the fatty acid chlorides of myristic acid, palmitic acid, margaric acid, stearic acid, arachidic acid or behenic acid and mixtures thereof.

In the context of the present invention, a liquid fatty acid chloride composition shall be understood to be a fatty acid chloride composition that is capable of flowing at the processing temperature and that can be applied to a substrate with the fatty acid chloride composition by conventional application methods. Typical viscosities of liquid fatty acid chloride compositions are in the range from 0.1 to 5000 mPa·s, in particular in the range from 0.2 to 50 mPa·s. The determination of the viscosities can be carried out in accordance with DIN 53019-09:2008.

The pre-drying of the cellulose-based fibrous substrate web in step a) is carried out in accordance with common drying methods, for example, drying by convection, particularly with impingement dryers. A further drying method is contact-drying, for example with drying cylinders, on which the cellulose-based fibrous substrate web is guided. In addition, drying by radiation, such as for example with infra-red dryers, is a further option for drying. Drying by convection is preferred. During pre-drying according to the invention (step a), the cellulose-based fibrous substrate web is dried to a moisture content in accordance with EN ISO 638:2008 of less than 5%, particularly less than 4%, particularly preferably at most 3% or at most 2%, i.e. a dry content >95%, particularly >96%, particularly preferably of at least 97% or at least 98%.

During convection drying, dry air, preferably with a relative humidity in accordance with DIN EN 20187 of less than 20% rH, in particular, flows through the pre-drying module and in this manner the cellulose-based fibrous substrate web is dried to a moisture content in accordance with EN ISO 638:2008 of less than 5%, particularly less than 4%, particularly preferably at most 3% or at most 2%, i.e. a dry content >95%, particularly >95%, particularly preferably of at least 97% or at least 98%.

In accordance with the invention, the cellulose-based fibrous substrate web in step a) is pre-dried to a moisture content in accordance with EN ISO 638:2008 of less than 5%, particularly of less than 4%, particularly preferably at most 3% or at most 2%. Typically, after step a) the cellulose-based fibrous substrate web has a moisture content of at least 0.1% or at least 0.2% or at least 0.5%.

Preferably, step a) is carried out in an enclosed atmosphere in a dry air flow with a relative humidity in accordance with DIN EN 20187 of less than 20% rH, preferably of less than 10% rH, particularly preferably of less than 5% rH. An enclosed atmosphere shall be understood to be an atmosphere which is isolated from the surrounding atmosphere, i.e. enclosed and thus can have different atmospheric conditions. The enclosed atmosphere is usually provided in the form of a housing and an air flow flows through it. The air flow has a humidity which is below the aforementioned relative humidity and is typically in the range from 0 to 20% rH. The utilized air flow has a temperature in the range from 20 to 150° C. at a volume of 0.1 to 100 m³ per 1 m² paper, or of 0.1 to 100 m³/h per 1 m²/h production speed, respectively, preferably at a volume of 1 to 10 m³ per 1 m² paper.

Preferably, the coating in step b) is carried out such that a total applied amount results that is in the range from 0.1 to 10% by weight, particularly 0.1 to 5% by weight, with respect to fatty acid chloride per g/m² basis weight of the cellulose-based fibrous substrate web. In other words, the applied amount of fatty acid chloride is defined such that the fatty acid chloride content is in the range from 0.1 to 10% by weight, particularly in the range from 0.1 to 5% by weight, with respect to the dry mass of the cellulose-based fibrous substrate web. Preferably, the liquid fatty acid chloride composition is applied in an amount such that the applied amount of fatty acid chloride is in the range from 0.1 to 10 g/m², particularly in the range from 0.1 to 5 g/m².

In step b), coating of the cellulose-based fibrous substrate web, pre-dried in step a), with a liquid fatty acid chloride composition is carried out by applying a layer of the liquid fatty acid chloride composition to the cellulose-based fibrous substrate web. Common application methods are in particular roll application, cylinder application, curtain application, spray application, coating application and combinations thereof. Accordingly, the coating module has at least one device for the application of the fatty acid chloride composition to the cellulose-based fibrous substrate web, for example, a device for roll application, cylinder application, curtain application, spray application or coating application, particularly a device for cylinder application. The following embodiments refer to step b) as well as the coating module.

Preferably step b) is carried out by a cylinder application method, particularly by offset gravure application. In a cylinder application method the liquid fatty acid composition is taken up by a metering roll rotating in a sump which contains the liquid fatty acid chloride composition and is transferred to a transfer roll contacting the metering roll. From the transfer roll, the liquid fatty acid chloride composition is transferred to the pre-dried cellulose-based fibrous substrate web which is guided between the transfer roll and a fibrous substrate carrier roll. As an example, further rolls can be arranged before the transfer roll which regulate the equalization of the applied film.

Preferably the surface of the metering roll has a plurality of recesses, in particular cells into which the liquid fatty acid composition can be taken up. The number and the volume of the cells determine which quantity of liquid fatty acid composition is taken up by the metering roll and can then be transferred to the transfer roll. The quantity which is transferred from the metering roll to the transfer roll determines the thickness of the layer of the liquid fatty acid composition on the transfer roll. The thickness of the layer of the liquid fatty acid composition determines the quantity which is transferred from the transfer roll to the cellulose-based fibrous substrate web. Further parameters which determine the transfer of liquid fatty acid composition are the diameter, circumferential speed, distances and contact forces between the metering roll and/or transfer roll.

In a preferred embodiment of the method according to the invention the coating in step b) is carried out with a cylinder application method, in particular an offset gravure-method.

Preferably, coating in step b) of the cellulose-based fibrous substrate web, pre-dried in step a), with the liquid fatty acid chloride composition is carried out at a relative humidity in accordance with DIN EN 20187 of less than 10% rH, particularly of less than 5% rH.

In a preferred embodiment of the method according to the invention, the liquid fatty acid chloride composition contains a fatty acid chloride as main component, which is selected from aliphatic monocarboxylic acids with 6 to 26 carbon atoms, preferably with 16 to 20 carbon atoms and mixtures thereof.

In a preferred embodiment of the method according to the invention, the fatty acid chloride is selected from aliphatic saturated fatty acid chlorides with 6 to 26 carbon atoms, preferably with 16 to 20 carbon atoms, and mixtures thereof.

In general, the liquid fatty acid chloride composition contains at least 5% by weight fatty acid chloride, preferably 50% by weight fatty acid chloride, in particular at least 90% by weight fatty acid chloride, each with respect to the total weight of the fatty acid chloride composition.

In a preferred embodiment of the method according to the invention, the liquid fatty acid chloride composition contains more than 95% by weight fatty acid chloride, with respect to the total weight of the fatty acid chloride composition.

In particular, the liquid fatty acid chloride composition contains less than 10% by weight, in particular less than 5% by weight organic solvent with a boiling point of below 150° C.

Preferably, step b) is carried out in an enclosed atmosphere with a dry air flow with a relative humidity in accordance with DIN EN 20187 of less than 20% rH, preferably of less than 10% rH, particularly preferably of less than 5% rH. The enclosed atmosphere is in particular achieved by a housing with an air flow flowing through it. The relative humidity of the air flow will not exceed the aforementioned values and can also be lower. The air flow utilized often has a temperature in the range from 10 to 80° C.

Preferably, step b) is carried out at temperatures in the range from 10 to 150° C., particularly in the range from 20 to 120° C. Preferably, the cellulose-based fibrous substrate web is tempered, e.g. to temperatures in the range from 40 to 120° C., particularly in the range from 50 to 100° C.

The thermal treatment in step c) of the cellulose-based fibrous substrate web coated with the liquid fatty acid chloride composition in step b) can be carried out with conventional contact-less or contact-free drying devices, such as for example radiation dryers and/or convection dryers. Preferably, the thermal treatment is carried out with radiation dryers, particularly infra-red radiation dryers. Accordingly the module for thermal post-treatment has at least one device for contact-less or contact-free drying, respectively, in particular at least a radiation dryer and especially at least an infra-red radiation dryer. The following discussions refer to step c) as well as the module for post-treatment.

In particular, a thermal post-treatment is carried out with infra-red radiation dryers at low ventilation numbers in the range from 0 to 20 changes of air per hour or in a range from 0 to 20 m³/h volumetric air flow per 1 m³ of dryer volume, respectively. During infra-red radiation drying, radiation with wave lengths in the range from 780 to 5000 nm is typically utilized. Typically, radiators heated electrically and/or with gas with a power in the range from 5 to 50 W/m² can be utilized as radiators for the radiation drying. The radiation drying causes a reduction of viscosity of the applied liquid fatty acid chloride composition, wherein a loss of mass of the fatty acid chloride composition by evaporation happens only to a small extent, if at all, due to the low ventilation numbers. With reduced viscosity, the liquid fatty acid chloride composition can penetrate better into the cellulose-based fibrous substrate web.

Preferably, step c) is carried out in an enclosed atmosphere in a dry air flow with a relative humidity in accordance with DIN EN 20187 of less than 20% rH, preferably less than 10% rH, particularly preferably less than 5% rH. The enclosed atmosphere is achieved in particular by means of a housing. In general the relative humidity of the air flow will not exceed the aforementioned values and can also be lower. The air flow flows over the cellulose-based substrate web. At ventilation numbers in the range from 0 to 20 the cellulose-based substrate web has a temperature in the range from 20 to 120° C.

In a preferred embodiment of the method according to the invention, in a further step d), the coated and thermally post-treated cellulose-based fibrous substrate web obtained from step c) is post-treated with a dry air atmosphere with a relative humidity according to DIN EN 20187 of less than 20% rH.

The cellulose-based fibrous substrate webs coated according to the method according to the invention are, for example, used in the production of corrugated board and are in particular processed into fruit/vegetable crates, stacking boxes, water-repellent/water-resistant packaging boxes. For the base paper, to be coated with the fatty acid chloride composition, all paper grades, preferably packaging papers, particularly, liner, kraft liner, test liner, corrugation medium and bogus paper can be used. In accordance with the invention, tissue papers, particularly with a basis weight in the range from 10 to 100 g/m², printing and writing papers with a basis weight in the range from 30 to 300 g/m² comprising virgin and/or recycled fibers can also be utilized. In accordance with the invention, the papers can be coated or uncoated. Provided that the paper is coated, the coatings are particularly from materials which contain hydroxyl groups, for example a starch-containing paper coating.

### DESCRIPTION OF THE FIGURES AND EXAMPLES

The invention will now be explained below using FIGS. 1 to 3 and the following example 1, without being limited to these embodiments.

FIG. 1 shows a magnified detail of FIG. 2 with the utilized modules of the method according to the invention,

FIG. 2 schematically shows a modular arrangement of the method according to the invention,

FIG. 3 schematically shows an embodiment of the coating module according to the invention as a three-roll application device.

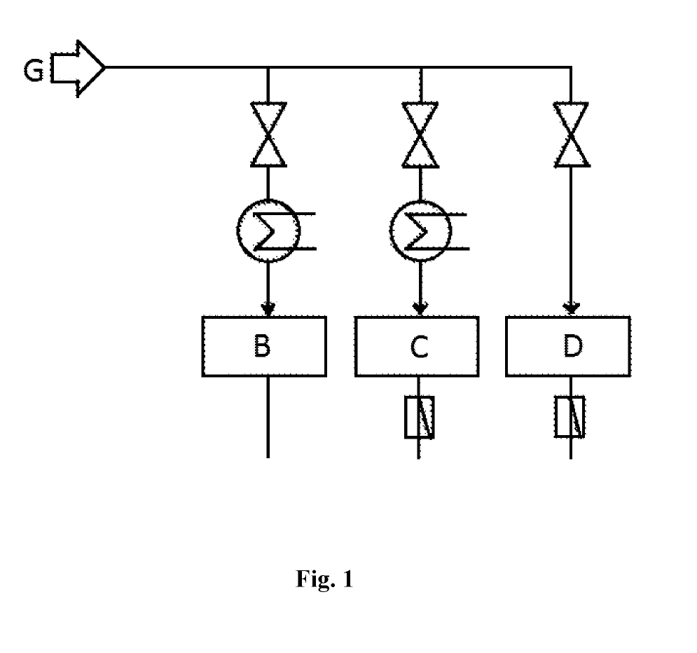

In FIGS. 1 to 3 the following reference numerals are used:
A unwinding module
B pre-drying module
C coating module
D first thermal post-treatment module
E second thermal post-treatment module
F winding module
G dry air inlet
H washing module
I ambient air inlet
J air outlet
1 metering roll
2 transfer roll
3 fibrous substrate carrier roll
4 impregnation bath
5 storage tank
6 application film
7 fibrous substrate web
8 collection tank
9 waste tank

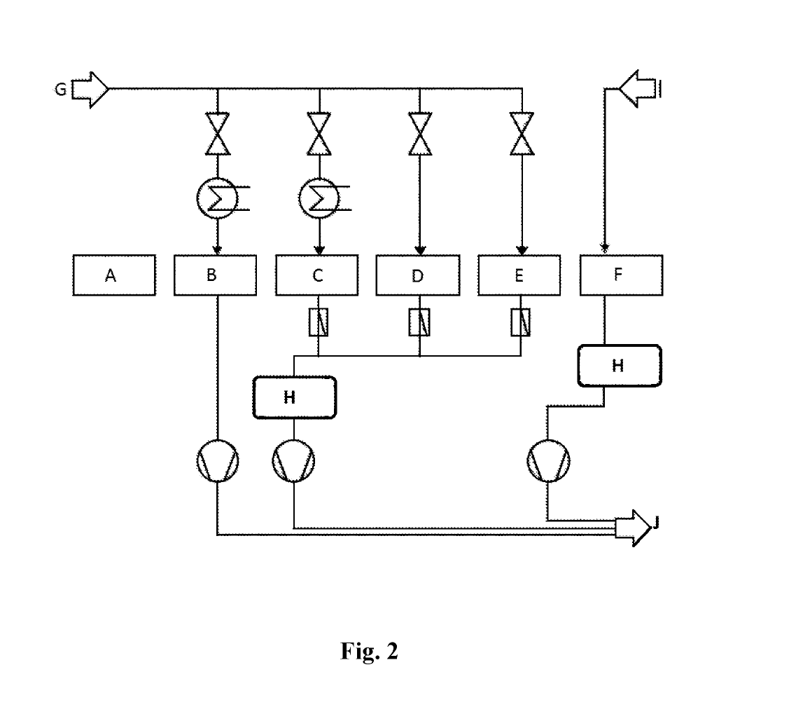

FIG. 1 shows a magnified detail of FIG. 2 with utilized modules of the method according to the invention. The cellulose-based fibrous substrate web is pre-dried in a pre-drying module B, in particular to a dry content of less than 10% in accordance with EN ISO 538:2008. In a coating module C, the pre-dried cellulose-based fibrous substrate web is coated with a liquid fatty acid chloride composition; in particular, a three-roll application device using the gravure method is used. A first thermal post-treatment module D is particularly formed by a radiation drier and heats the cellulose-based fibrous substrate web coated with the liquid fatty acid chloride composition, particularly with infra-red radiation.

FIG. 2 schematically shows a modular arrangement of the method according to the invention. The cellulose-based fibrous substrate web runs through the subsequently arranged modules. With an unwinding module A the cellulose-based fibrous substrate web is unwound particularly from a (paper) reel. Then the cellulose-based fibrous substrate web is pre-dried in the pre-drying module B. In the coating module C, the pre-dried cellulose-based fibrous substrate web is coated with a liquid fatty acid chloride composition and is tempered in a first thermal post-treatment module D. In a second thermal post-treatment module E, the coated cellulose-based fibrous substrate web is adjusted to the temperature conditions desired for further processing. In addition, the second thermal post-treatment module E serves as a kind of gate to separate a dry atmosphere in modules B to E from, for example, a more humid ambient air atmosphere. The provision of the second thermal post-treatment module E is optional. Coming from the second thermal post-treatment module E, the coated cellulose-based fibrous substrate web is wound up in a winding module F. According to the invention, the modules B to E are supplied from a dry air inlet G. After the dry air has flowed from the dry air inlet G through modules B to E, it is guided over one or more washing module(s) H, in which residual hydrochloric acid is washed out and released to the atmosphere through air outlet J. The winding module F is flushed with atmospheric air from the ambient air inlet I, then guided over one or more washing module(s) H and then released to the atmosphere via air outlet J.

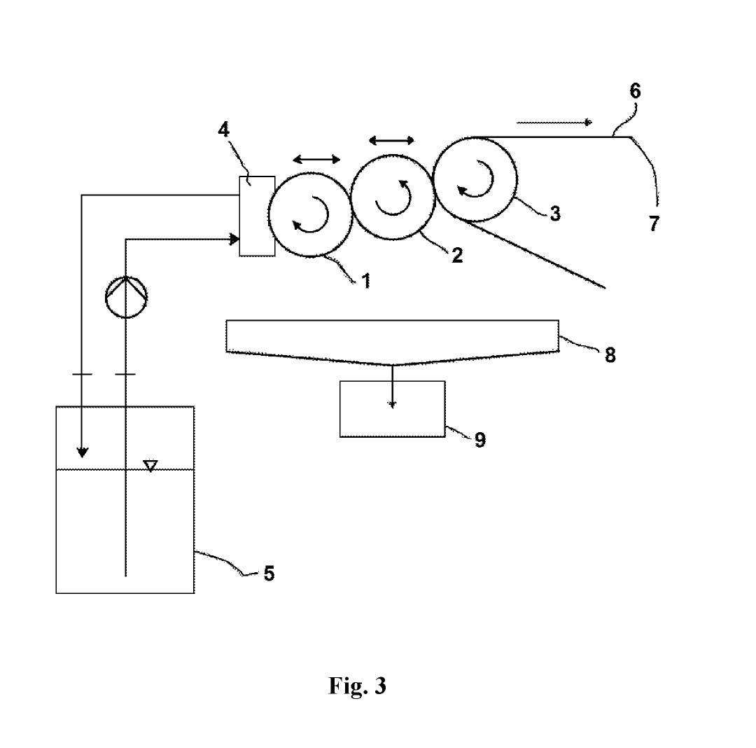

FIG. 3 schematically shows an embodiment of the coating module C according to the invention as a three-roll application device. In this regard, coating of a cellulose-based fibrous substrate web 7, particularly a paper, paperboard or cardboard web, is carried out in a contact operation employing the offset gravure method. A liquid fatty acid chloride composition is transferred from a storage container 5 into an impregnation bath 4. A metering roll 1 is running in the impregnation bath 4. The metering roll 1 is, for example, a roll coated with ceramic and engraved by laser with a low specific cell volume in the range from 1 to 10 μm cell depth. The metering roll 1 transports a certain quantity of fatty acid chloride composition from the impregnation bath 4, depending on the set parameters, for example, the cell volume and the rotational speed, and transfers it to a transfer roll 2, wherein a layer of fatty acid chloride composition is formed on the transfer roll 2 with a certain layer thickness. This layer of fatty acid chloride composition is transferred from the transfer roll 2 as an application film 6 to a cellulose-based fibrous substrate web 7, wherein the cellulose-based fibrous substrate web 7 is guided around a fibrous substrate carrier roll 3. Surplus fatty acid chloride composition is collected in a collection tank 8 and flows into a waste tank 9.

### EXAMPLES

In the following examples, tallow fatty acid chloride 50/50 from BASF SE, was used. This fatty acid chloride composition consists of 50% by weight of palmitoyl chloride (CAS number 112-67-4) and of 50% by weight of stearoyl chloride (CAS number 112-76-5).

The base paper used in the examples was a brown, unsized test liner from Thurpapier—Model Management AG in Weinfelden, and had a basis weight of 130 g/m² and a Cobb₆₀ value of 159 g/m².

In the following examples, palmitoyl chloride (CAS number 112-67-4) from BASF SE was used. Instead of this, a fatty acid chloride composition can also be used, which consists of 50% by weight of palmitoyl chloride and of 50% by weight stearoyl chloride (CAS number 112-76-5).

The base paper used in the examples was a brown, unsized test liner from Thurpapier—Model Management AG in Weinfelden and had a basis weight of 130 g/m² and a Cobb₆₀ value of 159 g/m².

The experimental set-up 1 for examples 1 to 4 was as follows. The base paper was pre-dried with contact drying at 60° C. and 5% rH to a dry content >96% (in accordance with EN ISO 638:2008). At the same temperature and humidity, the dried base paper was coated with fatty acid chloride with a roll application device (ZIL2140 Zehntner-Ink-Lox) employing an offset gravure method with a speed of 5 m/min. The gravure roll had 180 grid per cm at an angle of 45° and a specific cell volume of 3.8 cm³/m². The pressing force between the gravure roll and the transfer roll was 56 N/m. The transfer roll, made from rubber, had a Shore-A hardness of 40 and was pressed against the paper substrate with a line load of 152 N/m. The applied amount was 1 to 3 g/m². The coated paper substrate was then treated with two Krelus IR radiators (G7-50-2.5) for 12 seconds at 42 kW/m².

### Example 1

The treatment of the base paper was carried out analogously to experimental set-up 1, with the difference that the base paper was pre-dried with contact drying at 110° C. and about 5% rH to a moisture content of 1.7% (in accordance with EN ISO 638:2008). The paper treated in this manner had a Cobb₆₀ value of 19 g/m² on the coated front side and a Cobb₆₀ value of 72 g/m² on the back.

### Example 2 (Comparative Example)

The treatment of the base paper with the fatty acid chloride was carried out analogously to experimental set-up 1, with the difference that the base paper was not dried and had a moisture content of 5.9%. The paper treated in this manner had a Cobb₆₀ value of 20 g/m² on the coated front side and a Cobb₆₀ value of 86 g/m² on the back.

Obviously, the higher moisture content in the base paper resulted in poorer penetration of the fatty acid chloride into the paper and hence in a poorer product quality.

### Example 3

The treatment of the base paper with the fatty acid chloride was carried out analogously to experimental set-up 1, with the difference that the paper was pre-dried in an air circulation drying oven for 1 min at 105° C. The paper treated in this manner had a Cobb₆₀ value of 18 g/m² on the coated front side and a Cobb₆₀ value of 18 g/m² on the back.

### Example 4

The base paper was coated in a single layer of 5 g/m² with a 20% aqueous solution of polyvinyl alcohol (Mowiol 4-98, degree of hydrolysis >98%) on a coating table from the company Erichsen GmbH with doctor blade No. 2 and a coating speed of level 5 at 25° C. The paper obtained thereby was dried for 24 h at 105° C. The treatment of the coated base paper with the fatty acid chloride was carried out on the side coated with polyvinyl alcohol analogously to example 3. The paper treated in this manner had a Cobb₆₀ value of 4 g/m² on the coated front side and a Cobb₆₀ value of 58 g/m² on the back.

Obviously, coating the paper with polyvinyl alcohol leads to a surface reaction of the fatty acid chloride with the hydroxyl groups of the polyvinyl alcohol and thus to a lower penetration of the fatty acid chloride into the paper. This leads to a poorer Cobb₆₀ value on the untreated back.

In summary, examples 1-4 prove that pre-drying the paper web significantly improves the result of hydrophobization, particularly on the untreated back.

1.-12. (canceled)

13. A method for continuous coating of a cellulose-based fibrous substrate web with fatty acid chloride, comprising the steps of:
(a) pre-drying a cellulose-based fibrous substrate web to a moisture content in accordance with EN ISO 638:2008 of less than 5%;
(b) coating the pre-dried cellulose-based fibrous substrate web from step (a) with a liquid fatty acid chloride composition at a relative humidity in accordance with DIN EN 20187 of less than 20% rH and a temperature below the boiling temperature of the liquid fatty acid chloride composition;
(c) contact-free thermal treatment of the coated cellulose-based fibrous substrate web from step (b).

14. The method according to claim 13, wherein the liquid fatty acid chloride composition contains a fatty acid chloride selected from the group consisting of aliphatic mono carboxylic acid chlorides with 6 to 26 carbon atoms, and mixtures thereof.

15. The according to claim 14, wherein said fatty acid chloride is selected from the group consisting of aliphatic mono carboxylic acid chlorides with 16 to 20 carbon atoms, and mixtures thereof.

16. The method according to claim 14, wherein the fatty acid chloride is selected from the group consisting of aliphatic saturated fatty acid chlorides with 6 to 26 carbon atoms, and mixtures thereof.

17. The according to claim 16, wherein the fatty acid chloride is selected from the group consisting of aliphatic saturated fatty acid chlorides with 16 to 20 carbon atoms, and mixtures thereof.

18. The method according to claim 1, wherein the liquid fatty acid chloride composition contains at least 5% by weight fatty acid chloride with respect to the total weight of the fatty acid chloride composition.

19. The method according to claim 13, wherein the liquid fatty acid chloride composition contains more than 95% by weight fatty acid chloride with respect to the total weight of the fatty acid chloride composition.

20. The method according to claim 13, wherein at least one of steps (a) to (c) is carried out in an enclosed atmosphere with a dry air flow with a relative humidity in accordance with DIN EN 20187 of less than 20% rH.

21. The method according to claim 13, wherein the coating in step (b) is carried out with a roll application method.

22. The method according to claim 21, wherein said roll application method is an offset gravure method

23. The method according to claim 13, wherein the coating in step (b) is carried out with a total application in the range from 0.1 to 10% by weight with respect to fatty acid chloride per g/m² basis weight of the cellulose-based fibrous substrate web.

24. The method according to claim 13, wherein the thermal treatment of the coated cellulose-based fibrous substrate web in step (c) is carried out by radiation treatment.

25. The method according to claim 24, wherein said radiation treatment comprises an infrared radiation drying.

26. The method according to claim 13, wherein the coated and thermally treated cellulose-based fibrous substrate web obtained from step (c) is post-treated in a further step (d) in a dry air atmosphere with a relative humidity in accordance with DIN EN 20187 of less than 20% rH.

27. A coating device for the continuous coating of a cellulose-based fibrous substrate web with a liquid fatty acid chloride composition according to claim 13, comprising:
a pre-drying module;
a coating module and
a thermal post-treatment module,
wherein at least one of the modules of the coating device is enclosed and has an atmosphere of dry air with a relative humidity in accordance with DIN EN 20187 of less than 20% rH.

28. Use of a cellulose-based fibrous substrate web obtained by the method as defined in claim 13 for the production of a product selected from the group consisting of corrugated board base paper, packaging paper, carton, paperboard, hygienic paper, tissue, printing paper, writing paper, and combinations thereof.
